(19) United States
(12) Patent Application Publication
(10) Pub. No.: US 2009/0177332 A1
(43) Pub. Date: Jul. 9, 2009

(54) POWER SUPPLY CONTROL SYSTEM, POWER SUPPLY CONTROL DEVICE, CONTROL TERMINAL, POWER SUPPLY CONTROL METHOD, AND PROGRAM

(76) Inventor: TETSUJI YOKOCHI, Tokyo (JP)

Correspondence Address: NEC CORPORATION OF AMERICA, 6535 N. STATE HWY 161, IRVING, TX, 75039, US

(21) Appl. No.: 12/350,418

(22) Filed: Jan. 8, 2009

(30) Foreign Application Priority Data
Jan. 9, 2008 (JP) 2008-002342

(51) Int. Cl. G06F 1/26

(52) U.S. Cl. 700/296; 700/295

(57) ABSTRACT

A power supply control system, which allows the user to control, via a first network, the start or stop of power feeding to a power receiving apparatus connected to a second network, comprises a control terminal 13 connectable to the first network and a power supply control device 11 connected to the second network. The control terminal 13 sends a control command, which requests to supply power to a predetermined apparatus, to the power supply control device 11 connected to the second network, and the power supply control device 11 controls the power supply to the apparatus specified by the control command.

### REFERENCE TO RELATED APPLICATION

This application is based upon and claims the benefit of the priority of Japanese patent application No. 2008-002342, filed on Jan. 09, 2008, the disclosure of which is incorporated herein in its entirety by reference thereto.

### FIELD OF THE INVENTION

The present invention relates to a power supply control system, a power supply control device, a control terminal, a power supply control method, and a program, and more particularly to a power supply control system, a power supply control device, a control terminal, a power supply control method, and a program for remotely controlling the power on/off operation of any apparatus.

### BACKGROUND OF THE INVENTION

Patent Document 1 discloses a hub with the power supply function conforming to Power over Ethernet (registered trademark) (PoE; standardized as IEEE802af) and a power supply control device that sends a command to start or stop feeding power to the hub according to a schedule.

Patent Document 2 discloses a variable power supply system that has a power line communication unit to cause the DC variable power supply unit to be turned on/off according to the order stored in the memory.

[Patent Document 1]

Japanese Patent Kokai Publication No. JP-P2005-303593A

[Patent Document 2]

Japanese Patent Kokai Publication No. JP-P2003-304690A

The entire disclosures of Patent Documents 1 and 2 are incorporated herein by reference thereto.

The following analysis is given according to the present invention.

To realize energy saving with consideration for protecting the global environment, it is important to reduce the waste of power. The ability to remotely control the power of an apparatus is one of the ways to reduce the waste of power. However, in the configuration disclosed in Patent Documents 1 and 2, it is impossible to remotely control the power supply of a desired apparatus.

For example, though the power supply control device described in Patent Document 1 sends a command to a hub, which is connected to a LAN and equipped with the power feeding function, to specify the start or stop of power feeding to that hub according to a schedule registered in advance in the schedule memory, the document does not refer to the remote control of the power supply control device itself.

Patent Document 2 describes only the input operation unit and the power line communication unit of a sequence controller, indicating that the sequence controller is not designed for remote operation.

### SUMMARY

In view of the foregoing, it is an object of the present invention to provide a power supply control system, a power supply control device, a control terminal, a power supply control method, and a program that control power supply via a first network which is different from a network (second network) that controls power supply.

In a first aspect of the present invention, there is provided a power supply control system comprising: a control terminal that can be connected to a first network; and a power supply control device that comprises a receiving unit that receives a control command from the control terminal via the first network; and a power supply control unit that controls power supply to an apparatus, connected to a second network, according to the control command, as well as the devices that configure the power supply control system (control terminal, power supply control device, external terminal, power supply management server, etc.)

In a second aspect of the present invention, there is provided a power supply control method comprising: sending a control command, which requests to supply power to a predetermined apparatus, from a control terminal that can be connected to a first network to a power supply control device that is connected to a second network; and controlling, by the power supply control device, a power supply to the apparatus according to the control command.

In a third aspect of the present invention, there is provided a program causing a computer, which configures a power supply control device, to perform a process of receiving a control command, which requests to supply power to a predetermined apparatus, from a control terminal that can be connected to a first network; and a process of controlling a power supply to the apparatus according to the control command.

The meritorious effects of the present invention are summarized as follows.

The present invention allows the user to remotely control the power supply to any apparatus on a second network, which has the power supply control function, via a control terminal on another network (first network).

### BRIEF DESCRIPTIONS OF THE DRAWINGS

FIG. 1 is a block diagram showing a configuration of a power supply control system in a first exemplary embodiment of the present invention.

FIG. 2 is a block diagram showing a detailed configuration of a control terminal in FIG. 1.

FIG. 3 is a flowchart showing an operation of the control terminal of the power supply control system in the first exemplary embodiment of the present invention.

FIG. 4 is a sequence diagram showing flow of messages between the control terminal and a controlled apparatus in the power supply control system in the first exemplary embodiment of the present invention.

FIG. 5 is a block diagram showing the configuration of a power supply control system in a second exemplary embodiment of the present invention.

### PREFERRED MODES OF THE INVENTION

There are various possible modes in the present invention.

In the first aspect, the control terminal may accept a setting of a schedule for turning on/off the apparatus connected to the second network and may send a control command to the power supply control device according to the schedule.

After sending the control command, the control terminal may send an information collection command that checks an execution status of the control command and, based on a response to the information collection command, may record a control result of the power supply to the apparatus connected to the second network.

Power supply to the apparatus connected to the second network may be performed based on a Power over Ethernet (trademark) (PoE) method.

The second network may comprise a power line communication network where a power supply management server having a power line communication system is provided: and the power supply management server, which functions as the power supply control device, controls power supply via the power line communication system connected to a controlled apparatus.

Also, there is provided a power supply control device connected to a first network and a second network, the power supply control device comprising: a receiving unit that receives a control command from a predetermined control terminal connected to the first network; and a power supply control unit that controls power supply to an apparatus, connected to the second network, according to the control command.

In the power supply control device, the power supply to the apparatus connected to the second network may be performed based on a Power over Ethernet (trademark) (PoE) method.

In the power supply control device, the second network may comprise a power line communication network, the power supply control device further comprising a power line communication system wherein the power supply control device controls the power supply via the power line communication system connected to a controlled apparatus.

Further, there is provided a control terminal that can send a control command to the power supply control device wherein the control terminal may accept a setting of a schedule for turning on/off an apparatus, connected to the second network, and may send a control command to the power supply control device according to the schedule.

In the control terminal, after sending the control command, the control terminal may send an information collection command that checks an execution status of the control command and, based on a response to the information collection command, may record a control result of the power supply to the apparatus connected to the second network

Next, exemplary embodiments of the present invention will be described below in detail with reference to the drawings.

### First Exemplary Embodiment

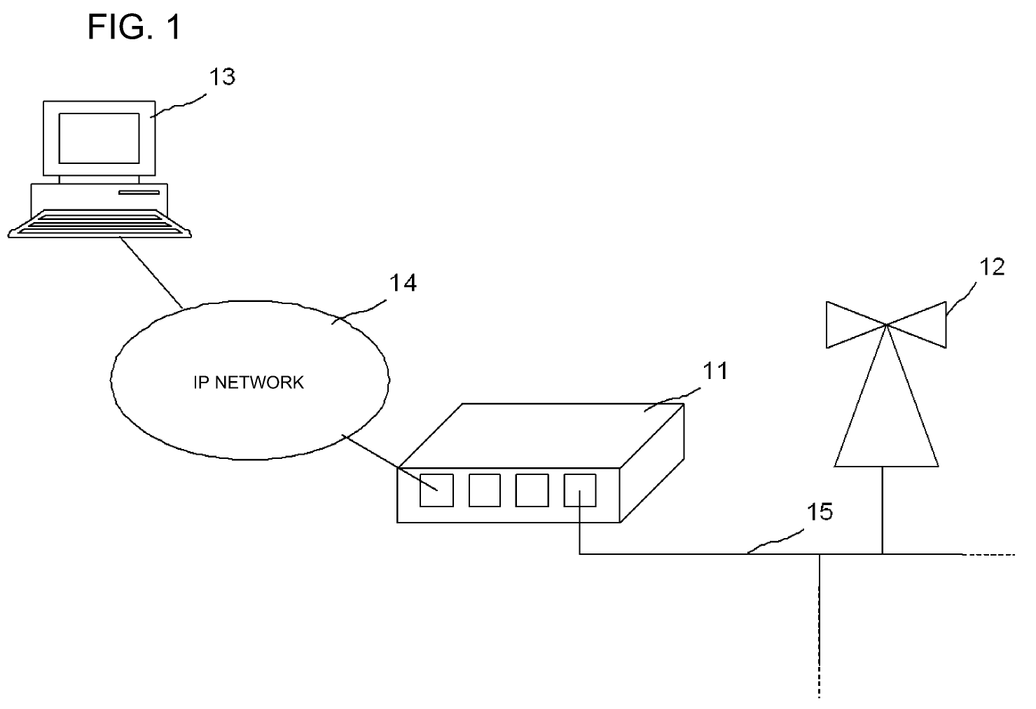

FIG. 1 is a diagram showing the general configuration of a power supply control system in a first exemplary embodiment of the present invention. Referring to FIG. 1, the power supply control system comprises a power supply control device 11, a power receiving terminal (controlled apparatus) 12, and a control terminal 13 of a network management system (hereinafter called an NMS).

The power supply control device 11 is configured by a hub connected to a local area network (LAN) 15 and equipped with the power feeding function conforming to Power over Ethernet (registered trademark). The power supply control device 11 can control the start or stop of power supply to the power receiving terminal (controlled apparatus) 12 connected to each port. In addition, the power supply control device 11 includes private MIB (Maintenance information Base) that allows the control terminal 13, connected to an IP network 14, to send a control command to the power supply control device 11 to control the start or stop of power feeding to the power receiving terminal (controlled apparatus) 12 connected to a port specified by the control command.

The power receiving terminal (controlled apparatus) 12, an apparatus that starts operation when powered by the power supply control device 11, is an IP telephone or a LAN access point in a company, a network camera, or a wireless base station.

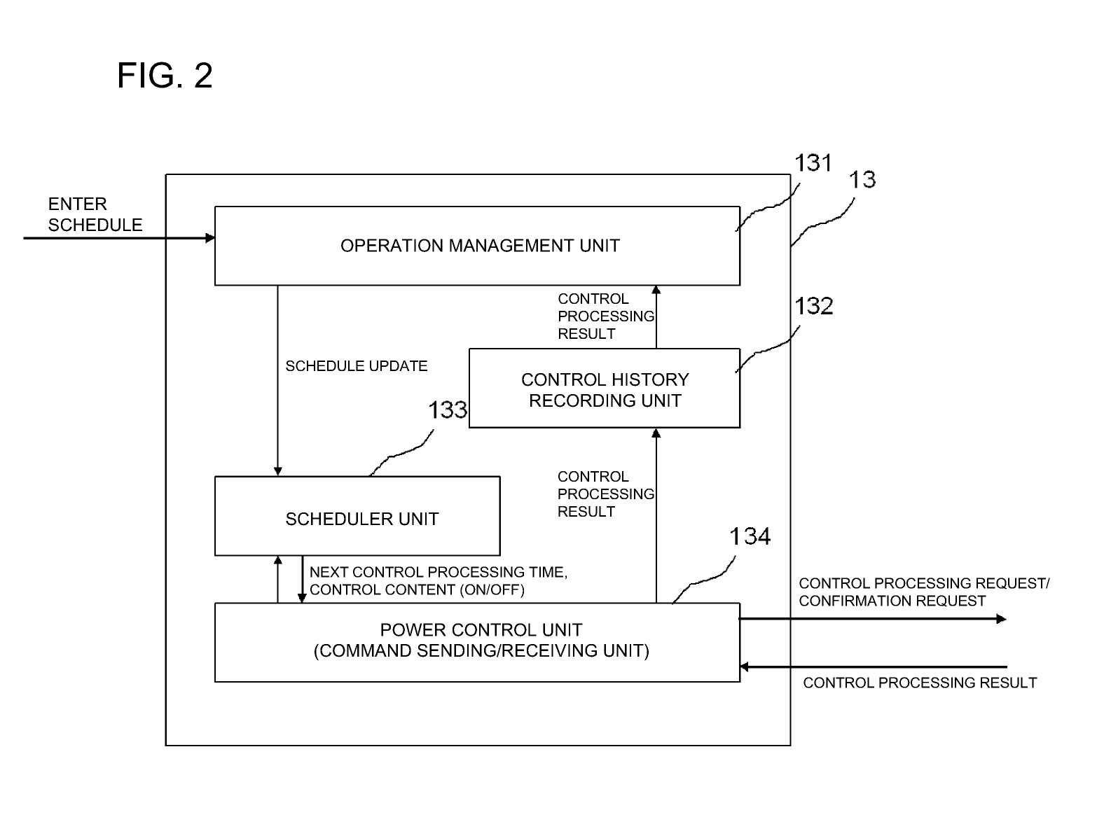

FIG. 2 is a block diagram showing an example of the configuration of the control terminal 13 shown in FIG. 1. Referring to FIG. 2, the control terminal 13 in this exemplary embodiment comprises an operation management unit 131, a control history recording unit 132, a scheduler unit 133, and a power control unit (command sending/receiving unit) 134.

The operation management unit 131 accepts the input of the schedule of power feeding start and power feeding stop of each power receiving terminal (controlled apparatus) 12 from a user (NMS operator) via an input device, not shown, and displays the on/off control result (control processing result) on a display device.

The control history recording unit 132 stores recorded control processing result that indicates whether or not the power feeding start control or the power feeding stop control of the power receiving terminal (controlled apparatus) 12 is normally completed.

The scheduler unit 133 stores the power feeding start or power feeding stop schedule information on each power receiving terminal (controlled apparatus) 12 received from the operation management unit 131 and, based on the schedule information, sends the next control processing time and the control content to the power control unit (command sending/receiving unit) 134. When the schedule information is updated or the power feeding start control or power feeding stop control is normally completed, the scheduler unit 133 sends the next control processing time and the control content to the power control unit (command sending/receiving unit) 134.

The registered items of the schedule information stored in the scheduler unit 133 includes information, which identifies the power receiving terminal (controlled apparatus) 12 such as the management number (identifier), IP address, and MAC address of the power receiving terminal (controlled apparatus) 12, and the control content such as the power feeding start, power feeding stop, and other control information.

The power control unit (command sending/receiving unit) 134 stores the next control processing time and the control content received from the scheduler unit 133. When the next control processing time arrives, the power control unit (command sending/receiving unit) 134 sends a control command to the power supply control device 11 to request it to start or stop feeding power to an apparatus corresponding to the control processing time. The control command used to request the power supply control device 11 to change the control value is, for example, the Set command of SNMP (Simple Network Management Protocol).

After sending the control command to request the power supply control device 11 to start or stop power supply, the power control unit (command sending/receiving unit) 134 sends the information collection command to the power supply control device 11 to check whether or not the processing requested by the control command is performed correctly and records the response result in the control history recording unit 132. The information collection command is, for example, the Get command of SNMP (Simple Network Management Protocol).

If the result of checking if the processing requested by the control command is performed correctly indicates that the processing is not performed correctly, the power control unit (command sending/receiving unit) 134 resends the control command to request the power supply control device 11 to start or stop feeding power. If the requested processing is not performed correctly even after the control command is resent a predetermined number of times, the power control unit (command sending/receiving unit) 134 sends a notification to the operation management unit 131 to indicate the condition. Upon receiving the notification from the power control unit (command sending/receiving unit) 134, the operation management unit 131 supposes that a timeout has occurred and notifies the user (NMS operator) of the error.

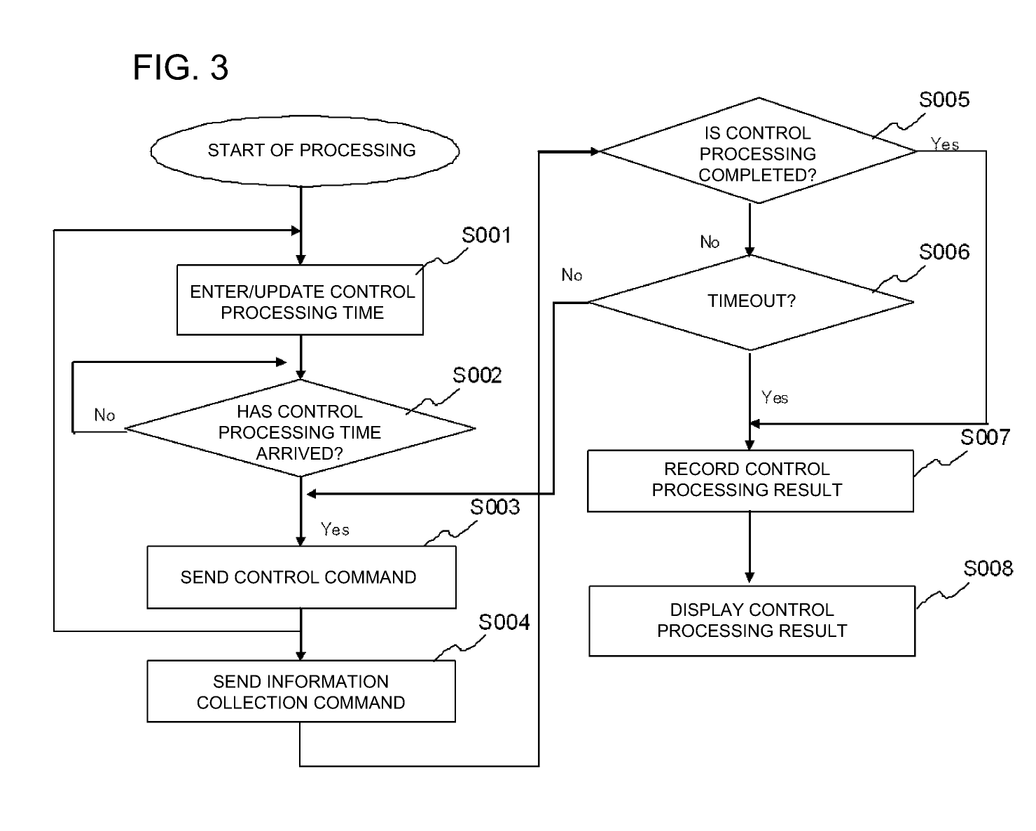

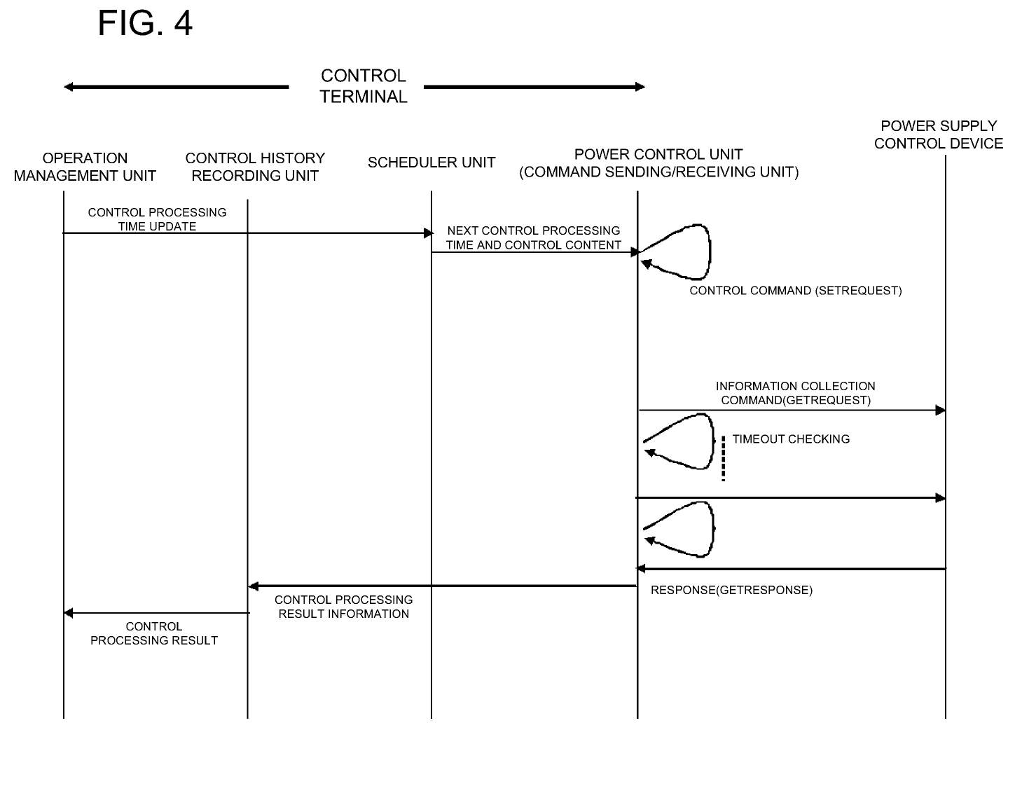

Next, the following describes the operation of this exemplary embodiment in detail with reference to the drawings. FIG. 3 is a flowchart showing the sequence of operations executed by the control terminal 13 in this exemplary embodiment, and FIG. 4 is a sequence diagram showing the flow of messages between the control terminal and the controlled apparatus in the exemplary embodiment. Referring to FIG. 3 and FIG. 4, when schedule information is updated, the scheduler unit 133 first updates the next control processing time and the control content stored in the power control unit (command sending/receiving unit) 134 of the control terminal 13 (step S001 in FIG. 3; “Next control processing time and control content” in FIG. 4).

Next, the power control unit (command sending/receiving unit) 134 checks if the next control processing time has arrived for each power receiving terminal (controlled apparatus) 12 (step S002 in FIG. 3; “Time checking” in FIG. 4).

If there is a power receiving terminal (controlled apparatus) 12 for which the next processing time has arrived (Yes in step S002 in FIG. 3), the power control unit (command sending/receiving unit) 134 sends the control command to the power supply control device 11 according to the control content with the power receiving terminal (controlled apparatus) 12, for which the control processing time has arrived, specified for the control command (step S003 in FIG. 3; “Control command” in FIG. 4).

Next, the power control unit (command sending/receiving unit) 134 sends the information collection command to the power supply control device 11 to check whether or not the control command has been executed correctly (step S004 in FIG. 3; “Information collection command” in FIG. 4).

On the other hand, if the result of the checking indicates that the control command has been executed correctly (Yes in step S005 in FIG. 3; “Response” in FIG. 4), the power control unit (command sending/receiving unit) 134 records the control processing result in the control history recording unit 132 (step S007 in FIG. 3; “Control processing result information” in FIG. 4).

If the result of the checking indicates that the control command was not executed correctly (No in step S005 in FIG. 3), the power control unit (command sending/receiving unit) 134 checks if the number of times the control command was resent is larger than a predetermined value (step S006 in FIG. 3; “Timeout checking” in FIG. 4). If the number of times the control command was resent is a predetermined value or smaller, the power control unit (command sending/receiving unit) 134 resends the control command (No in step S006 in FIG. 3). On the other hand, if the number of times the control command was resent is larger than the predetermined value (Yes in step S006 in FIG. 3), the power control unit (command sending/receiving unit) 134 records the control processing result in the control history recording unit 132 to indicate that a timeout has occurred (step S007 in FIG. 3; “Control processing result information” in FIG. 4).

Finally, the operation management unit 131 displays the result of control processing, recorded in the control history recording unit, on a predetermined display device (step S008 in FIG. 3; “Control processing result” in FIG. 4).

As described above, the system in this exemplary embodiment allows the user to operate the control terminal 13 to stop feeding power to the power receiving terminal (controlled apparatus) 12 in a remote location at night or during a vacation period during which the power receiving terminal (controlled apparatus) 12 need not be powered, thus avoiding wasteful power consumption.

Although one power supply control device 11 and one power receiving terminal (controlled apparatus) 12 are shown in the example in FIG. 1, the control terminal 13 in the NMS can manage two or more power supply control devices and send the control command to each of them. This configuration allows the control terminal 13 in the NMS to integrally manage the power of many receiving terminals (controlled apparatus) 12 in multiple LANs.

### Second Exemplary Embodiment

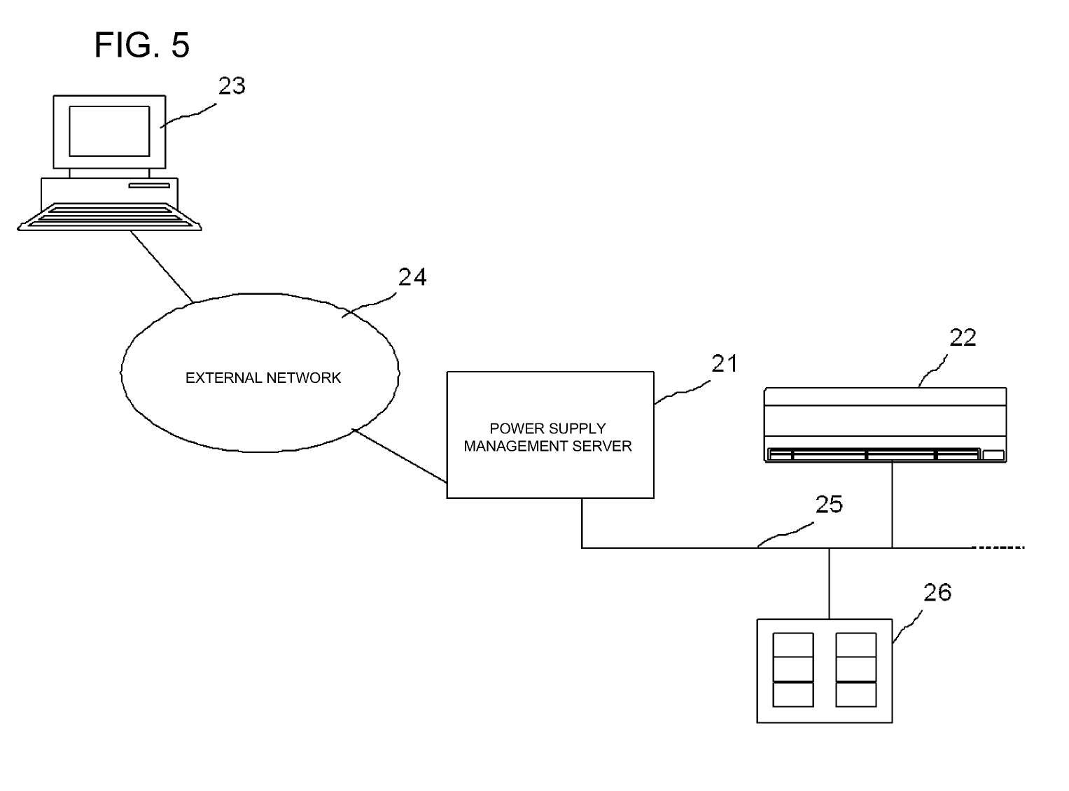

Next, a second exemplary embodiment of the present invention will be described with reference to the drawings. FIG. 5 is a diagram showing the general configuration of a power supply control system in the second exemplary embodiment of the present invention. Referring to FIG. 5, the power supply control system comprises a power supply management server 21, a controlled apparatus 22, an external terminal 23, and a power board 26.

The first exemplary embodiment and the second exemplary embodiment differ in that, in the second exemplary embodiment, the power supply management server 21 and the controlled apparatus 22 are connected via a power line 25 and the power supply management server 21 and the external terminal 23 are connected via an external network 24.

The power supply management server 21, which corresponds to the power supply control device 11 in the first exemplary embodiment, controls the start or stop of power supply to an apparatus specified by the control command sent from the external terminal 23.

The controlled apparatus 22 is, for example, home electric appliances, having a PLC(Power Line Communications) terminal unit that receives a power feeding start control command or a power feeding stop control command from the power supply management server 21 via PLC over the power line 25. This PLC terminal unit, which remains powered even when the power of the controlled apparatus 22 is turned off (standby state), controls the power on/off state of the controlled apparatus 22 according to the control command.

The external terminal 23 corresponds to the control terminal 13 in the first exemplary embodiment described above. The configuration and the operation are the same as those of the control terminal 13 and, so, the description is omitted.

As described above, the power supply control system in this exemplary embodiment allows the user to operate the external terminal 23 to stop feeding power to the controlled apparatus 22 in a remote location at night or during a vacation period during which the controlled apparatus 22 need not be powered, thus avoiding wasteful power consumption. In addition, the ability to register schedule information or to start feeding power to the controlled apparatus 22 via the external terminal 23, such as a mobile phone, allows the user to start or stop the operation of an air conditioner, one of the controlled apparatuses, at a predetermined time of a day or immediately before the user returns home.

While the present invention has been described with reference to the preferred exemplary embodiments, it is to be understood that the present invention is not limited to the exemplary embodiments described above but that further modifications, replacements, or adjustments may be made within the scope of the basic technical concept of the present invention.

For example, though control commands are sent and received using SNMP between the control terminal and the power supply control device or between the external terminal and the power supply management server in the exemplary embodiments described above, other network management protocols or control commands specific to the apparatus may also be used.

The program may be recorded on any recording medium and can be used to let a computer operate the intended functions and operation.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A power supply control system comprising:
a control terminal that can be connected to a first network; and
a power supply control device that comprises a receiving unit which receives a control command from said control terminal via said first network; and a power supply control unit which controls power supply to an apparatus, connected to a second network, according to the control command.

2. The power supply control system as defined by claim 1 wherein said control terminal accepts a setting of a schedule for turning on/off the apparatus connected to said second network and sends a control command to said power supply control device according to the schedule.

3. The power supply control system as defined by claim 1 wherein, after sending the control command, said control terminal sends an information collection command that checks an execution status of the control command and, based on a response to the information collection command, records a control result of the power supply to the apparatus connected to said second network.

4. The power supply control system as defined by claim 1 wherein power supply to the apparatus connected to said second network is performed based on a Power over Ethernet (trademark) (PoE) method.

5. The power supply control system as defined by claim 1 wherein said second network comprises a power line communication network where a power supply management server having a power line communication system is provided: and said power supply management server, which functions as said power supply control device, controls power supply via said power line communication system connected to a controlled apparatus.

6. A power supply control device connected to a first network and a second network, said power supply control device comprising:
a receiving unit that receives a control command from a predetermined control terminal connected to said first network; and
a power supply control unit that controls power supply to an apparatus, connected to said second network, according to the control command.

7. The power supply control device as defined by claim 6 wherein the power supply to the apparatus connected to said second network is performed based on a Power over Ethernet (trademark) (PoE) method.

8. The power supply control device as defined by claim 6 wherein
said second network comprises a power line communication network, said power supply control device further comprising a power line communication system wherein said power supply control device controls the power supply via said power line communication system connected to a controlled apparatus.

9. A control terminal that can send a control command to the power supply control device as defined by claim 6 wherein
said control terminal accepts a setting of a schedule for turning on/off an apparatus, connected to said second network, and sends a control command to said power supply control device according to the schedule.

10. The control terminal as defined by claim 9 wherein, after sending the control command, said control terminal sends an information collection command that checks an execution status of the control command and, based on a response to the information collection command, records a control result of the power supply to the apparatus connected to said second network.

11. A power supply control method comprising:
sending a control command, which requests to supply power to a predetermined apparatus, from a control terminal that can be connected to a first network to a power supply control device that is connected to a second network; and
controlling, by said power supply control device, a power supply to the apparatus according to the control command.

12. A program causing a computer, which configures a power supply control device, to perform:
a process of receiving a control command, which requests to supply power to a predetermined apparatus, from a control terminal that can be connected to a first network; and
a process of controlling a power supply to the apparatus according to the control command.
